(19) United States
(12) Patent Application Publication
(10) Pub. No.: US 2003/0186122 A1
(43) Pub. Date: Oct. 2, 2003

(54) Molded battery cup with protective/stiffening layer

(75) Inventors: Xuekun Xing, Richmond Heights, OH (US); Hiroki Sugiura, Beachwood, OH (US)

Correspondence Address: Mark Kusner, Mark Kusner Co., LPA, Highland Place - Suite 310, 6151 Wilson Mills Road, Highland Heights, OH, 44143, US

(73) Assignee: NTK Powerdex, Inc.

(21) Appl. No.: 10/108,586

(22) Filed: Mar. 27, 2002

(51) Int. Cl. H01M 2/08; H01M 2/02

(52) U.S. Cl. 429/185; 429/162; 429/175

(57) ABSTRACT

A package for a polymer battery, comprised of a generally rectangular sheet of a packaging laminate. The sheet of packaging laminate is comprised of a metallic foil layer disposed between two polymeric layers. A cavity is formed in the laminate at one end of the sheet. The cavity is generally rectangular in shape and has a bottom and four sides. The cavity is disposed in the sheet such that portions of the sheet define a flange that extends around at least three of the four sides of the cavity and a portion of the sheet defines a cover that is adapted to be folded over the cavity to overlay the flange. A protective/stiffening layer is disposed within the cavity along the four sides. The flange and the cover are hermetically sealed to each other.

### FIELD OF THE INVENTION

The present invention relates generally to electrochemical devices using liquid or polymer electrolytes or requiring hermetic packaging, and more particularly, to packaging and enclosures for encasing and hermetically sealing an electrolytic cell or battery.

### BACKGROUND OF THE INVENTION

Improvements in microelectronics have increased the demand for electrolytic cells and batteries that can be directly incorporated into electronic devices so as to produce a portable, finished package. As the improvements in microelectronics reduce the weight and size of the electronic device, it is important to maximize the power-per-unit weight and the power-per-unit volume that a battery cell can provide. One way to improve the power-per-unit volume is to reduce the size of the packaging or enclosure containing the electrolytic cell.

For extremely thin or unusually shaped batteries, flexible packaging has found advantageous applications. Flexible packaging can provide hermetic containment of the battery, and in addition, has several advantages over traditional rigid metal packaging. Foremost, flexible materials are lighter and they can conform more easily to the shape of the battery structure, thus providing easier and more cost effective manufacturing.

The advantages of flexible laminate packaging are particularly valuable for small, high-energy batteries. In general, the smaller the battery becomes in any one dimension, the greater is the contribution of the packaging to the overall power per unit weight and/or power per unit volume of the battery.

It is known to form batteries using “butter-cup packaging.” A butter-cup package is formed by molding or pressing a rectangular cavity into a first thin, flexible, planar sheet of a laminate material. The laminate material used to form the “butter-cup package” is typically comprised of a tough, outer polymer layer, a metal layer to form a hermetic barrier and an inner layer formed of an adhesive/sealant material. The rectangular cavity is dimensioned to receive an electrolytic cell. The formation of the cavity typically defines a flange that extends about the periphery of the cavity. With a battery cell disposed within the cavity, a second sheet or layer of the laminate is placed over the cell and flange. This second layer of laminate material is dimensioned to cover the cavity and the flange that surrounds the cavity. Heat and pressure are applied to the flange and the peripheral edge of the second layer to soften the adhesive/sealant layer of the laminate and seal the same together to form a closed package.

To form the cavity in such a laminate, it is necessary to stretch and to deform certain areas of the laminate, particularly the areas of the laminate that form the side walls and corners of the cup-like cavity. As indicated above, the inner layer of the package is formed of an adhesive/sealant material. The adhesive/sealant material lines the interior of the cup-like cavity and is exposed to the electrolytic cell therein. As noted above, the adhesive/sealant material is provided primarily to form the seal about the peripheral edge of the package. In this respect, the adhesive/sealant material is not as tough or durable as the outer, polymer layer. Consequently, the inner adhesive/sealant material is more susceptible to penetration by layers of the electrolytic cell. Shorting of the battery may occur, during assembly or use of the battery, if a conductive layer of the electrolytic cell should penetrate the adhesive/sealant material and contact the metallic, inner layer of the laminate.

The present invention overcomes these and other problems and provides a butter-cup-type battery package having reinforced side walls that reduces the likelihood of battery shorting, and further strengthens the structure of the cup-like package.

### SUMMARY OF THE INVENTION

In accordance with a preferred embodiment of the present invention, there is provided a package for a polymer battery, comprised of a generally rectangular sheet of a packaging laminate. The sheet of packaging laminate is comprised of a metallic foil layer disposed between two polymeric layers. A cavity is formed in the laminate at one end of the sheet. The cavity is generally rectangular in shape and has a bottom and four sides. The cavity is disposed in the sheet such that portions of the sheet define a flange that extends around at least three of the four sides of the cavity and a portion of the sheet defines a cover that is adapted to be folded over the cavity to overlay the flange. A protective/stiffening layer is disposed within the cavity along the four sides. The flange and the cover are hermetically sealed to each other.

In accordance with another aspect of the present invention, there is provided a battery, comprised of a generally rectangular electrochemical cell having planar top and bottom surfaces and four sides. The electrochemical cell has two battery leads attached to current collectors extending from one side of the cell. A package is formed from a first laminate sheet to have a cavity formed therein. The cavity has a bottom wall and four side walls that extend from the bottom wall to define an opening for receiving the cell and portions of the leads. A flange around the opening extends from at least three of the four side walls. A second laminate sheet overlays the cavity and the flange. The second laminate sheet is joined to the flange of the first laminate sheet and forms a seal therewith that hermetically seals the electrochemical cell within the cavity. The package has a protective/stiffening layer disposed within the cavity along the four side walls.

It is an object of the present invention to provide a package for small, electrochemical devices, wherein the package is formed of a flexible, laminate material.

Another object of the present invention is to provide a package as defined above that is less susceptible to shorting as a result of the electrochemical device contacting a metallic layer of the packaging laminate.

A still further object of the present invention is to provide a cup-like package for a battery cell, wherein the inner walls of the cup-like package are lined with a barrier material to reduce the likelihood of shorting and to strengthen the side walls.

These and other objects will become apparent from the following description of a preferred embodiment taken together with the accompanying drawings.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a partially sectioned, perspective view of a battery having an outer package according to the present invention;

FIG. 2 is an enlarged, sectional view taken along lines 2-2 of FIG. 1; and

FIG. 3 is a perspective view of a “butter-cup package,” illustrating a preferred embodiment of the present invention.

### DETAILED DESCRIPTION OF PREFERRED EMBODIMENT

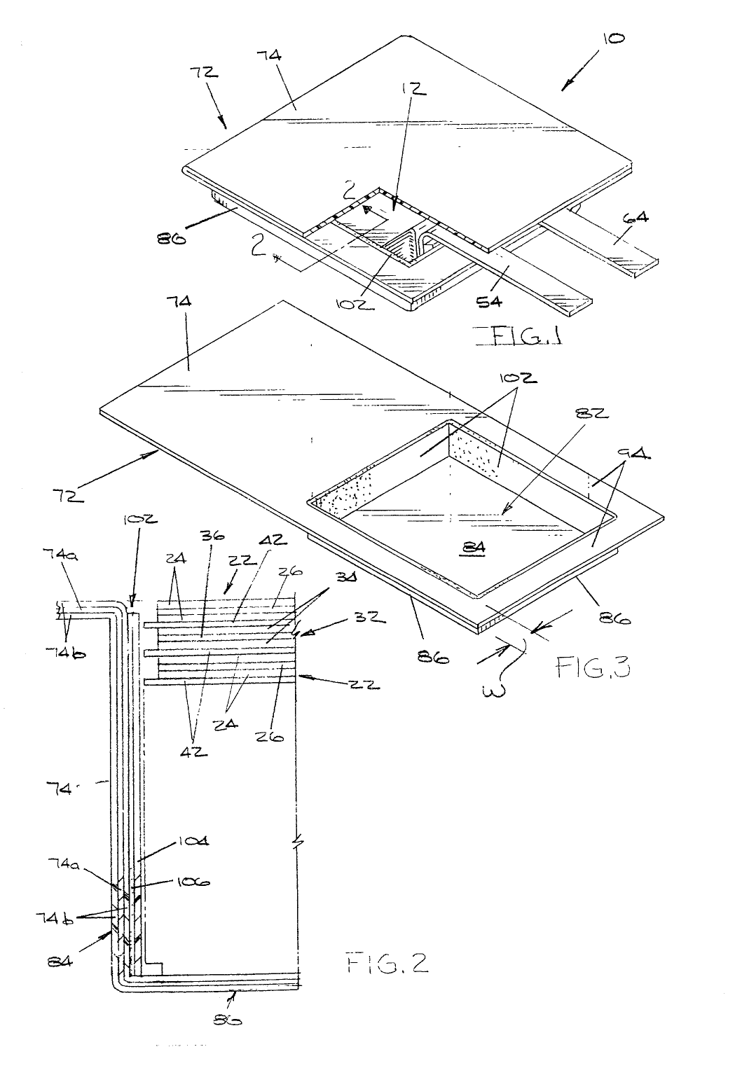

The present invention relates broadly to a multi-cell battery, and more particularly, to a package for containing a multi-layer cell. Referring now to the drawings wherein the showings are for the purpose of illustrating a preferred embodiment of the invention only, and not for the purpose of limiting the same, FIG. 1 shows a battery 10 comprised of a polymeric, electrolytic cell 12 and a package 72. Cell 12 is preferably a lithium-based electrochemical cell. Cell 12 may be any type of electrochemical cell, and is preferably a lithium-based electrochemical cell.

In the embodiment shown, cell 12 is comprised of a cathode section 22 and an anode section 32, as best seen in FIG. 3. Each cathode section 22 is comprised of two layers 24 of a cathode film. The film-forming cathode layer 24 is preferably comprised of a lithiated, metal oxide material, an electrically conductive material and a binder material. A current collector 26 formed of a metal screen or mesh is provided between cathode layers 24. Current collector 26 includes an outwardly extending tab or strip (not shown).

Anode section 32 is comprised of two layers 34 of an anode film having a current collector 36 disposed therebetween. The film-forming anode layers 34 are preferably comprised of a carbonaceous material, an electrically conductive material and a binder material. Current collector 36 includes an outwardly extending tab or strip (not shown).

Between anode section 32 and cathode section 22, a separator film layer 42 is disposed. Separator film layer 42 is preferably formed of a polymeric matrix containing an ionically conductive electrolyte. Current collectors 26, 36 are preferably formed of a metal mesh or screen having a thickness of about 25 μm to about 50 μm. The overall thickness of cell 12 is about 800 μm or less, and preferably about 500 μm or less.

Each current collector tab is joined together into a generally solid cathode tab weldment (not shown) that is attached to a cathode lead 54, as shown in FIG. 1. Cathode lead 54 is adapted to project outside of package 72 to form a positive lead of battery 10. In similar respects, each anode current collector tab (not shown) is joined together into a generally solid anode tab weldment (not shown) that is attached to an anode lead 64. Anode lead 64 is adapted to project outside of package 72 to form the negative lead of battery 10.

Package 72 is adapted to contain cell 12 in a hermetically sealed fashion and to have cathode and anode leads 54, 64 extending outwardly through package 72, as illustrated in FIG. 1. In accordance with the present invention, package 72 is formed of a sheet 74 of a laminate material. Laminate sheet 74 is generally comprised of a metallic foil layer 74a disposed between two polymeric layers 74b, as best seen in FIG. 2. In a preferred embodiment, metallic foil layer 74a is comprised of aluminum foil, and polymeric layers 74b are comprised of polypropylene (PP), polyethylene (PE) or other appropriate polymer films. The overall thickness of the laminate is typically between 0.10 mm and 0.15 mm.

In the embodiment shown, package 72 is formed from a laminate sheet 74 that is generally rectangular in shape. A generally rectangular cavity 82 is formed in one end of laminate sheet 74. Cavity 82 may be formed by conventional forming means, such as a stamping process or a molding process. Cavity 82 has a bottom wall 84 and four side walls that define an opening dimensioned to receive cell 12. Cavity 82 is dimensioned and disposed within laminate sheet 74 to define an outwardly extending flange 94 that is disposed about the opening defined by cavity 82. Laminate sheet 74 is dimensioned such that the other end thereof may be folded over cavity 82 so as to cover the same and cell 12, as shall be discussed in greater detail below.

In accordance with the present invention, a tough, protective/stiffening layer 102 is disposed within cavity 82 along the side walls, as illustrated in FIGS. 2 and 3. Layer 102 may be sprayed or coated onto the side walls. Materials that may be sprayed or coated to form layer 104 include by way of example and not limitation, epoxy and polycyanoacrylate. In a preferred embodiment of the present invention, protective/stiffening layer 102 is a preformed polymeric tape comprised of a polymer layer 104 and an adhesive layer 106, as best seen in FIG. 2. Polymer layer 104 is preferably formed of a tough, thin, polymer material having high dielectric properties that is inert to the components forming cell 12. Various plastic tapes find advantageous application in forming polymer layer 104. Such plastic materials may include, by way of example and not limitation, polyimide, polyester and the like. Polymer layer 104 preferably has a thickness of about 0.0005 inches to about 0.0015 inches. The width of polymer layer 104 is based upon the battery design, more specifically, the design of cavity 82. In this respect, protective/stiffening layer 102 has a width equal to the height of the side walls. Adhesive layer 106 is preferably formed of an electrically, non-conductive, thermosetting polymer, sealing material. Adhesive materials, such as silicone, find advantageous use as adhesive layer 106 in that this material is stable in the environment of a lithium-ion polymer battery. Other adhesive materials, such as rubber or resin, may also be used. The thickness of adhesive layer 106 is about 0.0005 inches to about 0.0015 inches. The total thickness of protective/stiffening layer 102 is preferably about 0.001 inches to about 0.003 inches. As indicated above, protective/stiffening layer 102 is disposed within cavity 82 along the surface of the side walls.

In this position, protective/stiffening layer 102 defines a protective barrier between laminate sheet 74 and battery cell 12. Protective/stiffening layer 102 also reinforces and stiffens the side walls to provide greater rigidity to the butter-cup package.

As indicated above, one end of laminate sheet 74 is dimensioned to be folded over so as to cover cavity 82 and overlay flange 94. Cathode and anode leads 54, 64 are disposed between cover portion 74b and flange 94, as best seen in FIG. 1. Pressure and sufficient heat are then applied to laminate sheet 74 along flange 94 so as to cause the outer polymer layer of laminate sheet 74 to soften and bond to the polymer layer of laminate sheet 74 to the U-shaped flange portion 94. As a result, a U-shaped, hermetic seal is formed around cell 12, thereby encasing cell 12 within cavity 82. The polymer layer of laminate sheet 74 also forms a seal around the cathode and anode leads 54, 64. In accordance with conventional practice, the seal formed along U-shaped flange 94 has a predetermined minimum width W that insures an adequate, hermetic seal.

The present invention thus provides a package 72, wherein a tough polymer material, i.e., protective/stiffening layer 102, is disposed between the edges of cell 12 and laminate sheet 74. Layer 102 also provides additional rigidity of package 72, thereby strengthening the corners of package 72.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

Having described the invention, the following is claimed:

1. A package for a polymer battery, comprised of:
a generally rectangular sheet of a packaging laminate, said sheet of packaging laminate is comprised of a metallic foil layer disposed between two polymeric layers;
a cavity formed in said laminate at one end of said sheet, said cavity being generally rectangular in shape and having a bottom and four sides, said cavity being disposed in said sheet such that portions of said sheet define a flange that extends around at least three of said four sides of said cavity; and
a protective/stiffening layer disposed within said cavity along said four sides.

2. A package for a polymer battery as defined in claim 1, wherein said protective/stiffening layer is comprised of a layer of polymer.

3. A package for a polymer battery as defined in claim 2, wherein said polymer is comprised of a material selected from the group consisting of polyester, polyimide, epoxy and polycyanoacrylate.

4. A package for a polymer battery as defined in claim 1, wherein said protective/stiffening layer is comprised of a strip of polymer.

5. A package for a polymer battery as defined in claim 4, wherein said adhesive layer is comprised of a material selected from the group consisting of silicon rubber and polycyanoacrylate.

6. A package for a polymer battery as defined in claim 1, wherein said protective/stiffening layer is a polymer deposited on said side walls.

7. A package for a polymer battery as defined in claim 6, wherein said protective/stiffening layer is sprayed onto said side walls.

8. A package for a polymer battery as defined in claim 7, wherein said protective/stiffening layer is epoxy or polycyanoacrylate.

9. A package for a polymer battery as defined in claim 1, including a cover that is dimensioned to overlay said cavity and said flange and to be sealed with said flange to hermetically seal said cavity.

10. A package for a polymer battery as defined in claim 9, wherein said cover is a portion of said rectangular sheet of packaging laminate and is dimensioned to be folded over onto said cavity and said flange.

11. In a battery, comprised of:
a generally rectangular electrochemical cell having planar top and bottom surfaces and four sides, said electrochemical cell having two battery leads attached to current collectors extending from one side of said cell;
a package formed from a first laminate sheet having a cavity formed therein, said cavity having a bottom wall and four side walls that extend from said bottom wall to define an opening for receiving said cell and portions of said leads;
a flange around said opening extending from at least three of said four side walls; and
a second laminate sheet overlying said cavity and said flange, said second laminate sheet joined to said flange of said first laminate sheet and forming a seal therewith that hermetically seals said electrochemical cell within said cavity, the improvement comprising: said package having a protective/stiffening layer disposed within said cavity along said four side walls.

12. A battery as defined in claim 11, wherein said protective/stiffening layer is comprised of a layer of polymer.

13. A battery as defined in claim 11, wherein said polymer is comprised of a material selected from the group consisting of polyester, polyimide, epoxy and polycyanoacrylate.

14. A battery as defined in claim 13, wherein said adhesive layer is comprised of a material selected from the group consisting of silicon rubber and polycyanoacrylate.

15. A battery as defined in claim 11, wherein said protective/stiffening layer is a polymer deposited on said side walls.

16. A battery as defined in claim 15, wherein said protective/stiffening layer is sprayed onto said side walls.
